(19) United States
(12) Patent Application Publication
(10) Pub. No.: US 2005/0277438 A1
(43) Pub. Date: Dec. 15, 2005

(54) Integrated key artifact

(76) Inventors: Jason G. Tilk, Grosse Pointe Park, MI (US); Josh G. Kaplan, Somerville, MA (US)

Correspondence Address: CHRISTOPHER DEVRIES;General Motors Corporation, Legal Staff, Mail Code 482-C23-B21, P.O. Box 300, Detroit, MI, 48265-3000, US

(21) Appl. No.: 10/850,766

(22) Filed: May 21, 2004

(51) Int. Cl. H04M 9/00; H04M 1/00

(52) U.S. Cl. 455/556.1

(57) ABSTRACT

An apparatus is provided for personal electronic access to voice communication, audio entertainment, and automotive functions. The apparatus comprises an integrated key artifact, comprising a physically and, optionally, electronically integrated combination of an electronic device for accessing automotive functions, an electronic voice communication device, and an electronic device for producing music from data files. An exemplary integrated key artifact comprises a physically and electronically integrated cell phone, MP3 player, and electronic key fob.

### FIELD OF THE INVENTION

The present invention generally relates to electronic devices for accessing automotive functions, known as key artifacts, and more particularly relates to a combination of a key artifact with voice communications and music player functions.

### BACKGROUND OF THE INVENTION

Electronic door keys for automobiles, also known as remote control door keys, electronic key fobs, or electronic key artifacts, are known in the art. Electronic key artifacts allow electronic push-button door opening within a predetermined distance from the automobile. Electronic key artifacts for automobiles are conventionally in the form of key fobs having trunk and door opening and locking buttons, as well as a panic button used to set off a car alarm. Electronic key fobs download coded commands via infrared (IR) emission or radio transmission to receivers in an automobile, where the commands are translated into appropriate actuator signals to implement the commands. Throughout this document, references made to IR downlinks should be understood to include radio downlinks, where appropriate.

Electronic remote engine starters are also known in the art. Remote engine starters allow the possessor of the remote engine starter to start the engine and heater or air conditioning unit of a vehicle, with or without unlocking the vehicle. The user of a remote engine starter can later enter the thermally comfortable vehicle with a completely warmed-up engine. Automobiles adapted to be used with electronic door keys and remote engine starters are known in the art.

Personal data assistants, or PDAs, are known in the art. Some PDAs have infrared communication facilities that allow them to transfer data to other, similarly equipped PDAs. PDAs can be programmed with software to perform a limited set of other functions. For example, software is available to permit use of infrared-equipped PDAs to remotely control television sets. Some PDAs function with a camera which stores digital images in the PDA. PDAs conventionally have a manual input facility comprising a touch-sensitive screen, as well as conventional push buttons. PDAs may provide wireless internet access.

Cellular telephones, or cell phones, are known in the art, ranging from phones for localized networks to Iridium phones with world-wide satellite-based relay antenna systems. Some cell phones can be equipped with digital cameras and internet access and can connect wirelessly to the internet to transfer photographs and other data. Cell phones may also provide programmable and downloadable features, such as games or other PDA-like functions. Global Positioning System (GPS) receivers have been incorporated in cell phones that can send the callers coordinates to the called party. For example, a person making a 911 call with a GPS-equipped cell phone may automatically transfer his GPS coordinates to the emergency dispatch center as inaudible data. Some cell phones allow “hands free” operation through the use of headsets and/or voice commands.

MP3 players are known in the art. MP3 players are electronic devices for playing music or other sounds from computer data files written in the MP3 format. The advantage of an MP3 player over compact disk players is that MP3 player require no high-precision spinning parts, so size, weight, and energy consumption are reduced. MP3 players read data from computer memory and create sound based upon the data read. Memory may be in the form of temporarily inserted “memory sticks,” which are memory modules adapted to customized connectors. MP3 players can be quite small. MP3 recorders are also known in the art.

The above give some examples of the plethora of electronic devices that are currently on the market. Consumers desire more capability with less carry weight and less complexity of use.

Accordingly, it is desirable to combine features of personal electronic devices into one convenient device. In addition, it is desirable to avoid combinations which might have usage conflicts. It is also desirable to combine electronic devices which have similar or overlapping areas of use. For example, it is desirable to combine electronic devices that would normally be carried on the person. It is also desirable to simplify the complexity of use. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

According to a broad aspect of the invention, there is provided an integrated key artifact for controlling certain automobile functions. A cellular telephone has an electronic device integrated therewith that includes a plurality of actuators for controlling the automotive functions.

### BRIEF DESCRIPTION OF THE DRAWINGS

The present invention will hereinafter be described in conjunction with the following drawing figures, wherein like numerals denote like elements, and

FIG. 1A shows an exemplary embodiment of an integrated key artifact;

FIG. 1B shows an exemplary embodiment of an attachment to an integrated key artifact.

FIG. 2A shows the exemplary embodiment of an integrated key artifact in a closed position;

FIG. 2B shows the exemplary embodiment of an integrated key artifact in a closed position from a different perspective than FIG. 2A.

FIG. 3 shows a block diagram of shared components of an exemplary embodiment of a key artifact;

FIG. 4A shows a portion of an exemplary automobile including adaptations to an exemplary integrated key artifact;

FIG. 4B shows a detail of portion of an exemplary automobile including adaptations to an exemplary integrated key artifact; and

FIG. 5 shows a block diagram of exemplary automotive functions accessible by the integrated key artifact.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

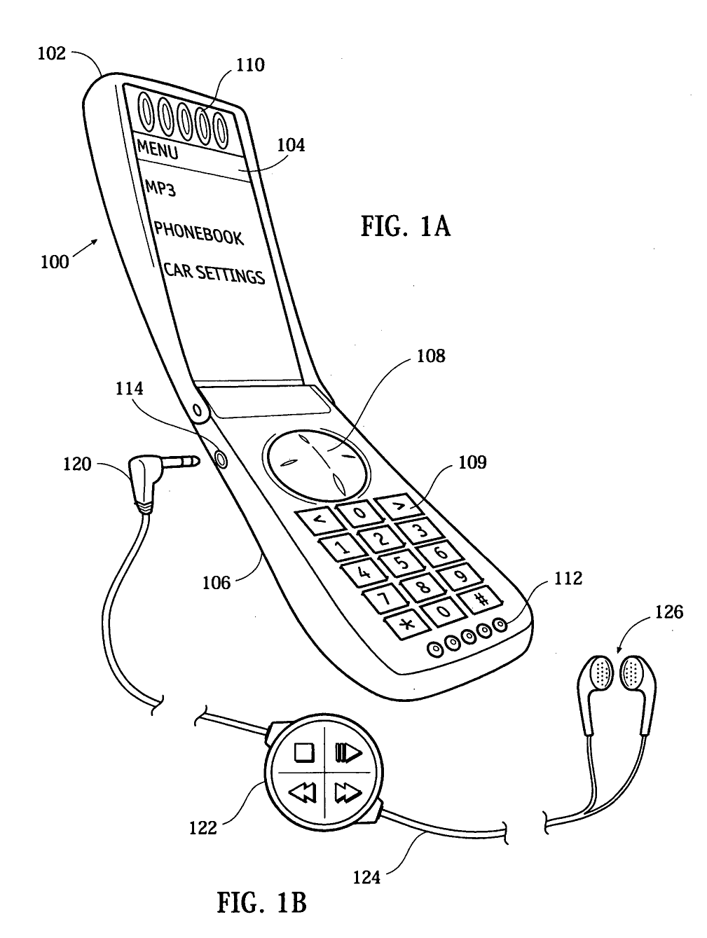

FIG. 1A shows exemplary integrated key artifact 100 in a conventional flip phone open position, with base 106 flexibly attached to lid 102. Lid 102 comprises display screen 104 and at least one speaker 110. Base 106 comprises two manual input facilities, key pad 109 and navigation pad 108, as well as at least one microphone 112 and earpiece connection port 114. Navigation pad 108 may be similar in function to a joystick and interacts with a menu on display screen 104. Other types of cursor-control devices are also contemplated.

For cell phone operations, embodiment 100 may be employed in a conventional manual manner such as pressing keys on keypad 109 to input a phone number and execute the call. A second conventional manual method may be used, wherein a pre-stored number may be selected from a menu on screen 104 using the navigation pad 108 and a button which is pushed to initiate the call. As a third alternative, cell phone functions may be accessed in a “hands free” manner using voice controls activated by speaking commands into microphone 112. The spoken commands may be translated into signals in a voice command processor and used to actuate cell phone functions or other functions. Headphones 126 (FIG. 1B) may be connected at port 114 using plug 120. Headphones 126 may be used for private listening, either to phone calls or to an integrated MP3 player. The MPs player translates computer data files into sound. The MP3 player may be located within base 106 or lid 102 and share the use of speakers 110 with the cell phone. A menu on display screen 104 may also be used to select MP3 files for play, using the navigation pad. The headphones126 may have inline controls 122 for MP3 play.

In an alternative embodiment, display screen 104 comprises a touch-sensitive display screen 104 and a stylus for activating menus and selecting items from menus. In another alternative embodiment, a hybrid voice-controlled menu system may be employed, wherein menus on screen 104 change and items may be selected in response to voice commands. The menu names may comprise the word that is the verbal command to open them, and each item may be represented on a menu by an item selection command word. A single display screen 102 may be used for displaying menus and other information relating to telephonic, MP3, and automotive control functions.

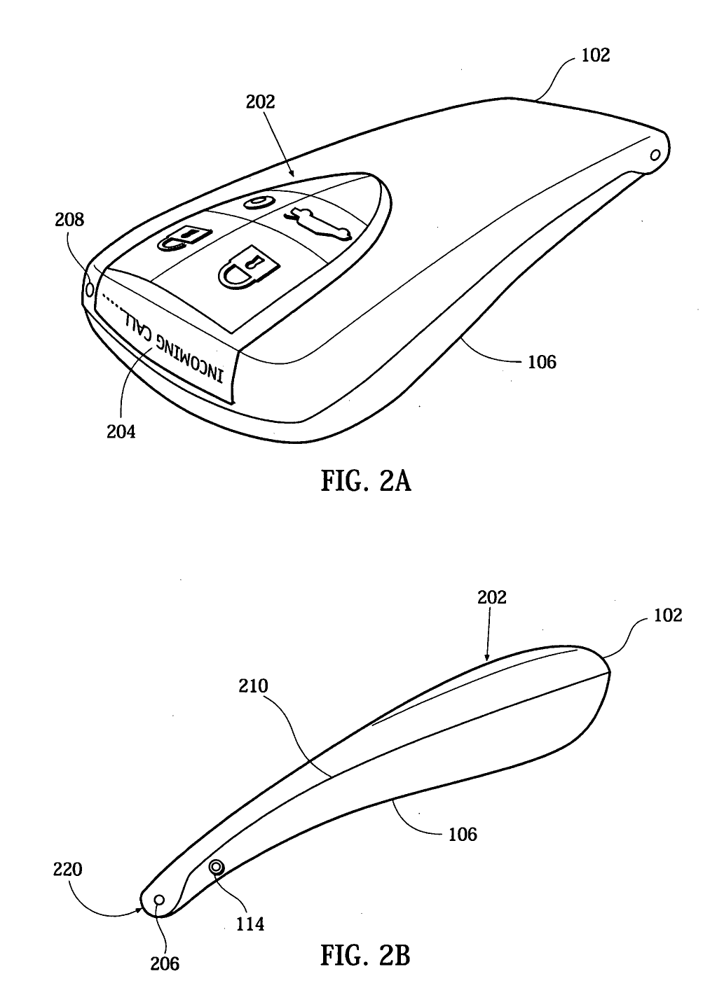

In an alternate physical configuration, microphone 112 may be located on the end of base 106, proximate the illustrated position in FIG. 1A, rather than on the closable surface of base 106. In an alternate physical configuration, speaker 110 may be located on base 106, proximate the flexible connection to the lid 102. Lid 102 may have an opening to allow access to the speaker 110 when lid 102 is closed. (See FIG. 2A).

FIG. 2A shows the integrated key artifact 100 in a closed position. A flexible connector 206 allows base 106 and lid 102 to meet along an edge seam 210. The outside surface of the lid 102 may comprises a set of key fob buttons 202 for remotely locking and unlocking an automobile, opening the trunk, activating a car alarm and/or similar binary automotive control functions. Pressing a key fob button 202 may cause a uniquely coded infrared light (IR) or radio signal to be sent through emitter window 208 to a receiver on an automobile, the received signal initiating the desired response. In some embodiments, the set of key fob buttons 202 may also include buttons for starting and stopping the engine, turning the air conditioner on or off, or turning the heater on or off. In a variation of that embodiment enabling remote control from greater distances, the automobile is equipped with an integral cell phone, and the signals may be sent via the cell phone portion of the integrated key artifact 100 to the integrated cell phone in the automobile, which transfers the signal to the appropriate actuator to act responsively to the received signal. In an alternate embodiment, automotive function commands originate as voice commands into microphone 112, are processed into automotive function commands, or signals, within integrated key artifact 100, and are then sent to the automobile either telephonically or through the IR or radio emitter 208 (FIG. 2A). In some alternate embodiments, any function of the integrated key artifact 100 may be initiated by voice command.

In either a closed or open position of the lid 102, integrated key artifact 100 may activate an external display 204 which provides information to the user. In some embodiments, particular messages may be accompanied by audible clues from speaker 110. For example, a low battery warning may be accompanied by an alarming sound. For further example, an incoming call may be accompanied by a unique sound or by muting the MP3 player, if in use. It is preferred to have the external display configured to be readable when the integrated key artifact 100 is standing on its flexibly connected end 220 (FIG. 2B).

MP3 operation may be accomplished by selecting an MP3 menu and then selecting a playable file from that menu. The files may be stored in dedicated or shared memory within the integrated key artifact. The memory may be fixed or removable. The sounds produced by the MP3 portion of the integrated key artifact 100 may be produced in speakers 110, or in headphones 126, or in other speakers connected to the integrated key artifact 100.

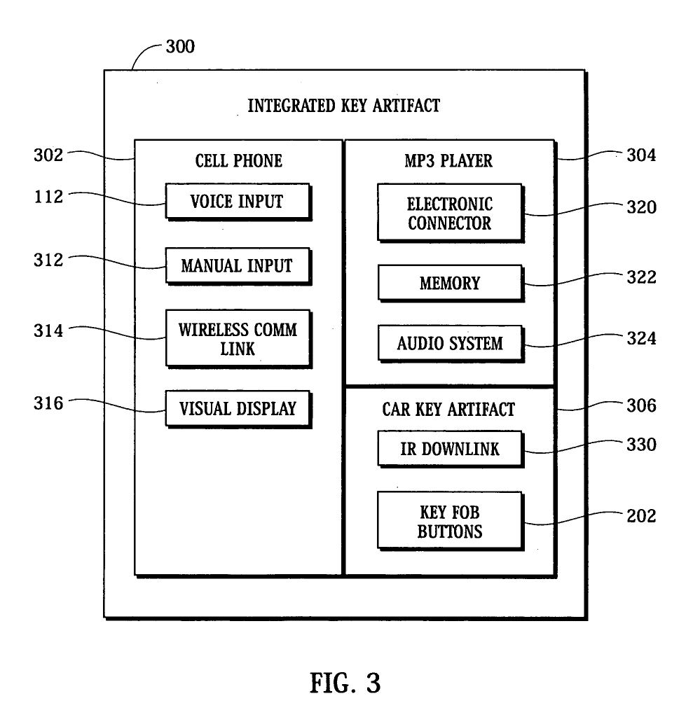

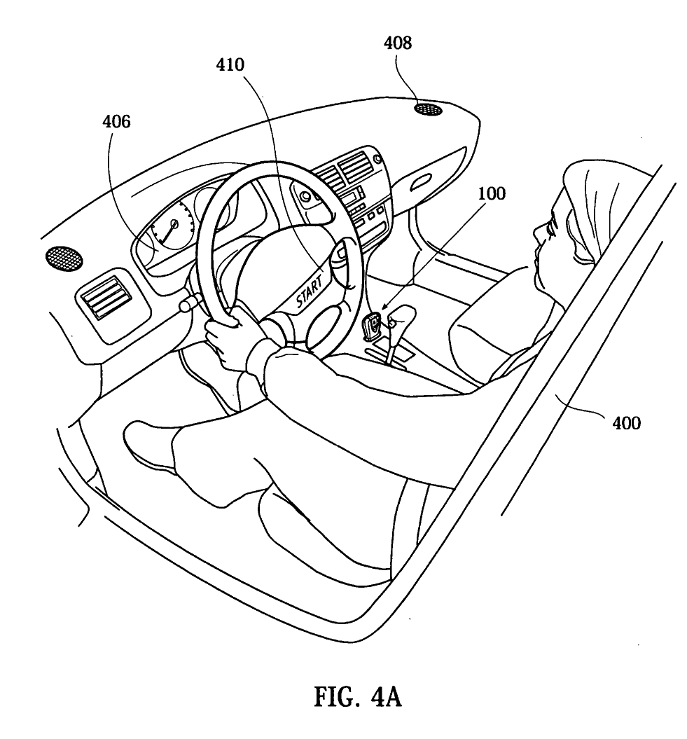

FIG. 3 shows sharable resources within an exemplary embodiment of the integrated key artifact 300. Cell phone 302 is the only one of the three integrated devices 302, 304, and 306 which, standing alone, requires a voice input component 112 (FIG. 1A). Voice input component 112 (FIG. 1A), or microphone 112 (FIG. 1A), is the entryway for telephone conversations and other voice functions. Other voice functions may include voice-activated, or voice-controlled, functions, as with “hands free” cell phone operation or voice-activated key fob functions (lock, unlock, open trunk, locate car, and panic) or additional voice-activated automotive functions (i.e., heater on/off, air conditioner on/off, check location). In an alternate embodiment additionally having an MP3 recorder, the integrated key artifact 300 permits recording of MP3 files from voice input using microphone 112 (FIG. 1A). In a variation of this embodiment, MP3 files may be recorded from telephone conversations. In a variant of the conversation recording embodiment, the conversation may first be recorded in a non-MP3 format, and then translated into MP3 format automatically or on command. The extensive memory 322 associated with MP3 players 304 may be ideal for providing electronic recording of telephone conversations.

Cell phone 302 manual input facilities 312 are typically more extensive than MP3 player 304 manual input facilities or car key artifact 306 manual input facilities. Accordingly, the telephone keypad 109 may be shared with the MP3 player 304 and the car key artifact 306. In some embodiments, key fob buttons 202 may be duplicated on key pad 109 using dedicated or multi-function keys. In another embodiment, key fob buttons 202 are on keypad 109. MP3 player 304 control keys may be dedicated or multi-function keys on key pad 109. In a particular embodiment, pressing the car alarm key fob button, “panic” key, or other designated button may activate MP3 recording. In some embodiments, manual input 312 may be by navigation pad 108 or by a stylus on a touch-sensitive display screen 104. Other manual input devices are also contemplated.

The wireless communications link 314 may handle voice signals for the cellular telephone 302 functions as well as data, including internet access, for any PDA-like functions included within cell phone 302 functions. In some embodiments, the MP3 player 304 may send and receive MP3 files over the wireless communications link 314. In some embodiments, pressing the “panic” key of the key fob buttons 202 of the car key artifact 306, or other designated key, may initiate a 911 call and send sound collected by microphone 112 over the telephone line. In an embodiment having a GPS receiver also integrated into the cell phone, the GPS coordinates of the caller may also be sent or recorded. In some embodiments, wireless communications link 314 may complete a call to a cell phone integral to the automobile to activate key fob functions and/or additional automotive functions. In an embodiment, the cell phone integral to the automobile, or an element thereof, may be integral to the engine ignition control electronics, and operable to enable or disable the engine via a phone call.

The visual display 316 may include display screen 104, external display 204, and other visual status indicators, such as a light indicating the power is on. Car key artifacts 306, or key fobs 306, conventionally have one or no visual display features. MP3 players 304 conventionally have less visual display 316 capability than cell phones 302. Accordingly, the visual display 316 of the cell phone 302 is shared by the MP3 player and, optionally, by the car key artifact 306. In some embodiments, MP3 player 304 displays are selected from a menu on display screen 104 and MP3 player 304 functions are presented as menu items selected and monitored from screen 104. In some embodiments, key fob functions are presented as menu items and selected and monitored from menus displayed on screen 104. External display 204 may be shared between functions. For example, external display 204 may show the name of an MP3 file being played, the caller ID of a person calling the cell phone 302, or the last key fob button 202 pushed. External display 204 is configured to be visible when a flip-phone embodiment 100 of the cellular telephone is closed. In some embodiments, the external display 204 is dedicated to one or two functions only. Cellular telephones other than flip phones may be integrated into an integrated key artifact.

The IR downlink 330 is unique to the car key artifact 306 and may be accessed by the cell phone 302 to downlink data to PDAs or similarly equipped devices. For example, a phone conversation could be IR downlinked into a PDA or laptop computer for storage. Similarly, the MP3 player 304 may IR downlink a music file or other recording to a PDA or laptop computer. IR downlink 330 may download command sequences to be stored onboard the automobile and executed later. For example, a driver who gets off work in Phoenix, Ariz. at 5 p.m. may store a command sequence to turn on the engine and air conditioner at 4:45 p.m. As discussed above, in some embodiments IR downlink 330 may be radio downlink 330.

Key fob buttons 202 may be unique to the car key artifact 306. As discussed above, they may be shared, in various embodiments, to initiate phone calls and MP3 recording.

The audio system 324 of an MP3 player 304 will generally be superior to that of a cellular telephone 302, so it is preferred to share that audio system 324 with the cell phone 302 and, optionally, with the car key artifact 306. Audible outputs of the cell phone 302 may be routed to speaker 110 through the MP3 player's audio system 324, thereby muting the MP3 player during phone calls. Likewise, audible indicators may be generated for key fob button 202 operations and piped through the MP3 player 304 audio system 324.

MP3 players 304 conventionally have more memory 322 than cell phones 302. In some embodiments, MP3 player 304 memory 322 may be removable. In such embodiments, the cell phone and key fob may have dedicated memories in addition to making shared use of MP3 player 304 memory 322. In some other embodiments, all memory is fixed and only the MP3 player 304 memory 322 is shared. In yet some other embodiments, all memory 322 is shared MP3 player 304 memory 322.

The electronic connector 320 for MP3 player 320 may be shared by the cell phone 302 and car key artifact 306. The connector 320 may comprise a universal serial bus (USB) connector 320 originally used for downloading and uploading MP3 files from a personal computer. Cell phones 302 conventionally have electronic connectors for recharging batteries and for data transfer, including encoding and programming the cell phone. The data transfer requirements may be met using the USB connector 320. In some embodiments, the original cell phone connector may be retained, and the USB connector 320 may be added. In an embodiment, a plurality of electronic connectors 320 are configured to be simultaneously engaged. In an alternate embodiment, one or more electronic connectors 114 (FIG. 1) may not be simultaneously engaged. Car key artifacts 306 typically have no electronic connectors 320. In many embodiments, the battery, or other power source, which powers the integrated key artifact 300 will be shared by all components 302, 304, and 306. Accordingly, the recharging connector may be shared by all components 302, 304, and 306 of the integrated key artifact 300. In embodiments with the capability to reprogram key fob button 202 functions, the data transfer connector may be shared with car key artifact 306.

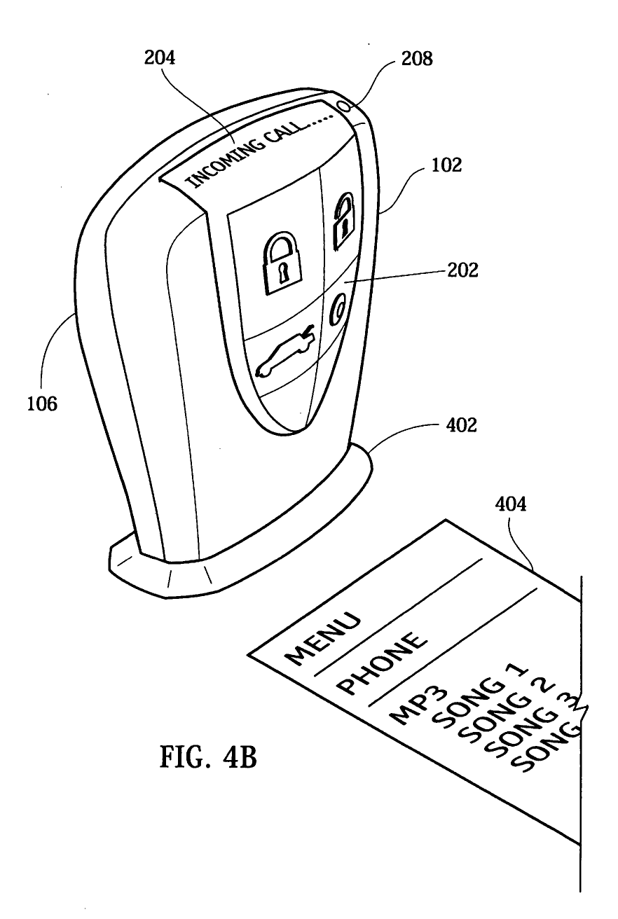

FIG. 4A shows an exemplary integrated key artifact 100 in use in automobile 400. In most embodiments, automobile 400 may be adapted to receive integrated key artifact 100 in a receptacle 402 (FIG. 4B) in a console, dashboard, or similarly convenient location within automobile 400. Integrated key artifact 100 may be received in receptacle 402 in a closed position of the integrated key artifact 100 (see FIG. 2A). The bottom of the receptacle may comprise one or more electronic connectors adapted to mate with electronic connectors 320 on the end 220 (FIG. 2B) of the integrated key artifact 100 when the integrated key artifact 100 is received in receptacle 402.

Automobile 400 comprises a visual display 406, which may be a computer-generated visual display. In an embodiment, integrated key artifact 100 uses visual display 406 for presenting information which would be displayed on display screen 104 when the integrated key artifact 100 is in an open position (See FIG. 1A). In an alternate embodiment, automobile 400 comprises a dedicated display screen 404 associated with receptacle 402 for displaying the data from display screen 104. Automobile 400 may comprise an audio system comprising a speaker 408. In many embodiments, sound signals in the integrated key artifact 100 are routed through electronic connectors 320 and into the automotive audio system to speaker 408. The sound signals may originate from any of the devices 302, 304, or 306 (FIG. 3) of the integrated key artifact 100.

Automobile 400 comprises a start pushbutton 410 which may be enabled by a security code within the integrated key artifact 100. In an embodiment, the integrated key artifact 100 is used to initiate a telephone call from any distance to a cellular telephone integrated into the automobile 400, download the security code to the automobile, and download a commend to start the engine. The cellular telephone integrated into automobile 400 comprises exemplary elements of a wireless communication link between the integrated key artifact 100 and automobile 400. In some embodiments, the security code may be downloaded automatically when the integrated key artifact 100 is inserted into receptacle 402. In some embodiments, the automobile will start when pushbutton 410 is pushed or when an appropriate voice command is given through microphone 112 of the integrated key artifact 100 in the receptacle 402. In a particular embodiment, the integrated car key artifact 100 comprises voice recognition devices.

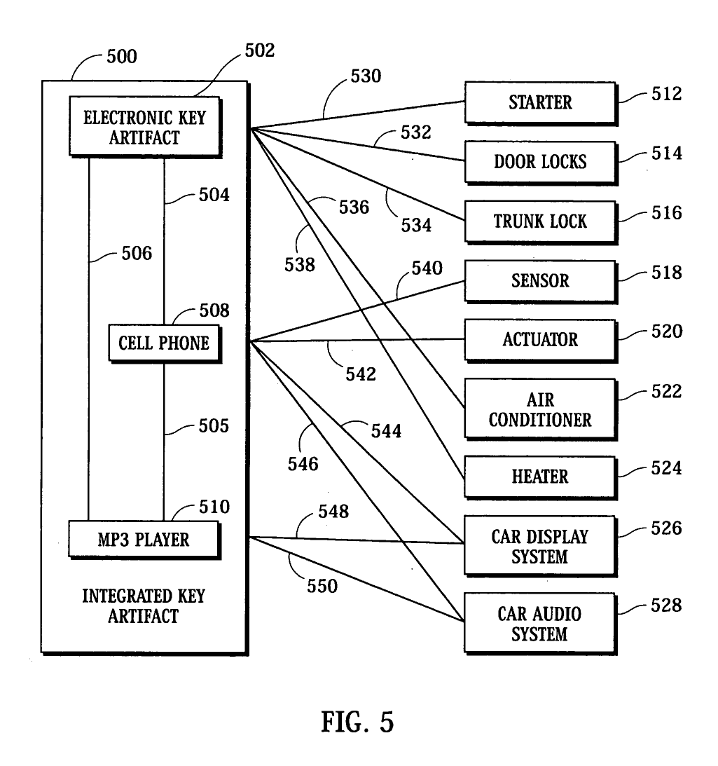

FIG. 5 shows an exemplary set of automotive systems that may be controlled or influenced by the exemplary integrated key artifact 500. Integrated key artifact 500 comprises electronic key artifact 502, cell phone 508, and MP3 player 510 connected by communication links 504-506. Starter 512, door locks 514, and trunk lock 516 are conventionally controlled by the electronic key artifact 502 over IR downlinks 530, 532, and 534, respectively. In an embodiment, additional binary functions (on-off, locked-unlocked, open-closed) may be added to electronic key artifact 502 functions, such as remotely operating the air conditioner 522 or heater 524 over IR downlinks 536 and 538, respectively.

Modem automobiles comprise a number of sensors 518 and actuators 520 beyond those inherent in key fob functions (i.e., door lock actuators and door lock sensors), some of which may provide inputs to computers, such as engine ignition controllers, within the automobile 400. In an embodiment, automobile 400 may be configured to transfer data from these additional sensors 518 and actuators 520 over links 540 and 542, respectively, to the integrated key artifact 500. The data thus transferred may be analyzed by a program within integrated key artifact 100 to predict servicing requirements or to initiate alarms.

The car display system 526 and car audio system 528 may be slaved to the cell phone 508 component of the integrated key artifact 100 using links 544 and 546, respectively. The car display system 526 and car audio system 528 may be slaved to the MP3 player 510 component of the integrated key artifact 100 using links 548 and 550, respectively. In some embodiments, the car display system 526 may be slaved to a cellular phone having a voice interpretation and printing function for the hearing impaired, while the MP3 player 510 uses the car audio system 528 to amuse passengers.

In a particular embodiment, link 504 maybe used to transfer a voice command, received and translated into a command format in the cell phone 508, to the electronic key artifact 502 for use in controlling, for example, the starter 512. Likewise, MP3 player functions may be controlled with commands formatted from voice data in the cell phone 508 and transferred over link 505 to the MP3 player. In some embodiments, all functions of the integrated key artifact 500 may be voice activated.

Referring to FIG. 2A and FIG. 5, a lid 102 to a cellular phone may be integrated with a programmable key fob 502 and sold as an accessory to the cell phone 508. The integrated key fob 502 may be programmed by the consumer in a simplified version of the method used to program TV remote control devices. For example, the integrated key fob 502 is placed in a programmable mode via activation of a switch, a particular button is pressed on the integrated key fob 502 to indicate what button is to be programmed, and the corresponding button on the original key fob is pressed to downlink the code for that button into the integrated programmable key fob 502.

To maximize consumer convenience, the integrated key artifact 100 should be wearable technology. In an embodiment, the integrated key artifact 100 may attach by clips, as are known in the art of cell phone clips, to a belt or purse.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

1. An integrated key artifact for controlling certain automotive functions, comprising:
a cellular telephone;
an electronic device integrated with said cellular telephone; and
a plurality of actuators associated with said electronic device for controlling said certain automotive functions.

2. The integrated key artifact of claim 1, wherein said integrated key artifact is responsive to a signal for controlling said certain automotive functions.

3. The integrated key artifact of claim 2, wherein said signal comprises a voice command signal.

4. The integrated key artifact of claim 2, wherein said signal initiates an electromagnetic transmission from the integrated key artifact.

5. The integrated key artifact of claim 2, further comprising an MP3 player operatively coupled to said cellular telephone for downloading data through the cellular telephone.

6. The integrated key artifact of claim 5, wherein said the MP3 player is responsive to a first control signal.

7. The integrated key artifact of claim 6, wherein said control signal comprises a voice command signal.

8. The integrated key artifact of claim 6, further comprising a recorder operably coupled to said cellular telephone for recording sounds received by said cellular telephone.

9. The integrated key artifact of claim 8, wherein said recorder comprises an MP3 recorder.

10. The integrated key artifact of claim 9, wherein said MP3 recorder is responsive to a second control signal.

11. The integrated key artifact of claim 1, further comprising an electronic connector for connecting the integrated key artifact to an automobile, wherein said automobile is adapted to process signals from said integrated key artifact.

12. The integrated key artifact of claim 11, further comprising at least first and second electronic information displays.

13. The integrated key artifact of claim 12, wherein the cellular telephone includes a closable lid, and wherein said first electronic information display is externally visible when said lid is closed.

14. An integrated key artifact for controlling certain automotive functions in a vehicle, the integrated key artifact comprising:
a cellular telephone; and
an electronic car key artifact operably coupled to said cellular telephone for generating telephone signals, said vehicle being responsive to said telephone signals to control said automotive functions.

15. The integrated key artifact of claim 14, further comprising an electronic processor for processing data files which represent sounds.

16. The integrated key artifact of claim 15 wherein said vehicle includes a first source of electrical power and wherein said integrated key artifact includes a second source of electrical power which is recharged by said first source of electrical power.

17. The integrated key artifact of claim 14, wherein one of said certain automotive functions is electronic ignition.

18. The integrated key artifact of claim 14, wherein one of said certain automotive functions is an audio system.

19. The integrated key artifact of claim 14 wherein one of said certain automotive functions is a video system.

20. The integrated key artifact of claim 14, wherein one of said certain automotive function comprises an automotive navigation system.

21. An integrated key artifact, comprising:
a cellular telephone;
an electronic automotive key artifact integrated with said cellular telephone; and
an MP3 player integrated with said cellular telephone and said electronic automotive key artifact.

22. The integrated key artifact of claim 21, wherein said cellular telephone, said key artifact, and said MP3 player are integrated in a unitary structure.

23. The integrated key artifact of claim 21, further comprising an integrated speaker.

24. The integrated key artifact of claim 21, further comprising an integrated with a visual display.

25. The integrated key artifact of claim 21, further comprising an integrated voice command processor.

26. The integrated key artifact of claim 22, further comprising a programmable key fob button set.
